(19) United States
(12) Patent Application Publication
(10) Pub. No.: US 2014/0244676 A1
(43) Pub. Date: Aug. 28, 2014

(54) Discovering Title Information for Structured Data in a Document

(71) Applicant: INTERNATIONAL BUSINESS MACHINES CORPORATION, Armonk, NY (US)

(72) Inventors: Donna Karen Byron, Boston, MA (US); Alexander Pikovsky, Laxington, MA (US); Matthew B. Sanchez, Austin, TX (US)

(73) Assignee: International Business Machines Corporation, Armonk, NY (US)

(21) Appl. No.: 13/778,901

(22) Filed: Feb. 27, 2013

(51) Int. Cl. G06F 17/30

(52) U.S. Cl. CPC G06F 17/30424
USPC 707/758

(57) ABSTRACT

A method, system, and computer program product for discovering title information for structured data in a document are provided in the illustrative embodiments. An instance of structured data is identified in a document. A search direction is identified relative to a location of the instance, wherein a title describing the instance is located in a document portion in the search direction from the instance. A sentence is selected in the document portion. A determination is made whether the selected sentence qualifies as a title by determining whether an independent clause in the selected sentence includes a verb-phrase. Responsive to the selected sentence qualifying as the title, the selected sentence is designated as a candidate title for the instance.

### BACKGROUND

1. Technical Field

The present invention relates generally to a method, system, and computer program product for natural language processing of documents. More particularly, the present invention relates to a method, system, and computer program product for discovering title information for structured data in a document.

2. Description of the Related Art

Documents include information in many forms. For example, textual information arranged as sentences and paragraphs conveys information in a narrative form.

Some types of information are presented in a structured form, such as tabular organization, a graph, a chart, or an image representation. For example, a document can include tables for presenting financial information, organizational information, and generally, any data items that are related to one another through some relationship.

Natural language processing (NLP) is a technique that facilitates exchange of information between humans and data processing systems. For example, one branch of NLP pertains to transforming a given content into a human-usable language or form. For example, NLP can accept a document whose content is in a computer-specific language or form, and produce a document whose corresponding content is in a human-readable form.

### SUMMARY

The illustrative embodiments provide a method, system, and computer program product for discovering title information for structured data in a document. In at least one embodiment, a method for discovering title information for structured data in a document is provided. The embodiment includes identifying an instance of structured data in a document. The embodiment further includes identifying a search direction relative to a location of the instance, wherein a title describing the instance is located in a document portion in the search direction from the instance. The embodiment further includes selecting a sentence in the document portion. The embodiment further includes determining whether the selected sentence qualifies as a title by determining whether an independent clause in the selected sentence includes a verb-phrase. The embodiment further includes designating, responsive to the selected sentence qualifying as the title, the selected sentence as a candidate title for the instance.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example of structured data whose title and sub-title information can be identified in accordance with an illustrative embodiment;

FIG. 4 depicts a block diagram of an example configuration for discovering title information for structured data in a document in accordance with an illustrative embodiment; and

FIG. 5 depicts a flowchart of an example process for discovering title information for structured data in a document in accordance with an illustrative embodiment.

### DETAILED DESCRIPTION

The illustrative embodiments recognize that documents subjected to NLP commonly include structured data, such as tabular data, which presents content in the form of one or more tables. Information presented as structured data often has a corresponding title and descriptive text in the vicinity of the data structure in the document. The title, sub-titles, descriptive text of the title, and other similar data in the document aid in understanding the content of the structured data.

The illustrative embodiments recognize that structured data requires specialized processing or handling for interpreting the content correctly and completely. For example, a table containing values in table cells is not of much use unless something in the document informs about the name or purpose of the table, describes the contents of the table, or both.

The illustrative embodiments recognize that typically, title text performs the function of providing such information as the name, nature, or purpose of a structured representation of data. The illustrative embodiments also recognize that often, a title is also accompanied by sub-titles, descriptive text, or a combination of similarly purposed information. The sub-titles, descriptive text, or a combination of similarly purposed information are collectively referred to as sub-titles within this disclosure.

Titles, such as table captions, frequently describe the general meaning of information in the data structure. For example, a table including numbers may have a caption “Statement of Revenues and Expenses for the city of Chicago.” The caption serves as a title for the table. Without the title, the table is just a collection of numbers. The title provides the necessary context for those numbers—that they represent some part of the revenues or expenses for the city of Chicago. Additional information, such as “in Millions of Dollars” provides further description about the title, the values in the data structure, or both. Such additional information acts as a sub-title. As an example, and without implying any limitation thereto, sub-titles are frequently used to provide information about time period, units, and/or denomination pertaining to the contents of the structured data.

The illustrative embodiments also recognize that the title and accompanying sub-titles are located proximate to the structured data itself. A title or sub-title is unlikely to be separated from the corresponding structured data by several paragraphs or pages. For example, the title and sub-titles are likely to be found within a small number of sentences. For example, a title is usually located within a paragraph distance from the data structure.

A title may also be located in sentences between the data structure and a separator, such as a page break, section break, a section header markup, and other similarly purposed separators in documents of various types. For example, similar separators or document components exist for similar purposes but in differing forms in HyperText Markup Language (HTML) documents, Extensible Markup Language (XML) documents, Portable Document Format (PDF) documents, different text editor specific documents, spreadsheet formats, and other types of documents.

Identifying a title and sub-title associated with a data structure in a document is a difficult problem. For example, a NLP engine typically expects visual clues or tag references to identify information that may be regarded as a tile of a structured data. The illustrative embodiments recognize that not only are titles not always presented with clean and consistent visual clues or within well defined tags, even if the expected visual clues or tags are present in a document, what may be present within the visual clues or tags may not be the title information at all.

The illustrative embodiments used to describe the invention generally address and solve the above-described problems and other problems related to the limitations of presently available NLP technology. The illustrative embodiments provide a method, system, and computer program product for discovering title information for structured data in a document.

The illustrative embodiments identify the title information associated with a structured data instance in a document by using grammatical or linguistic logic of such information. For example, the illustrative embodiments recognize that in many cases in the English language, a title includes only noun-phrases (NP) in the independent clause of a sentence. More generally, the illustrative embodiments recognize that a title does not include a verb-phrase (VP) in an independent clause of the sentence. An independent clause is a clause that is meant to be a complete sentence, even if grammatically incorrect, in a given text. An independent clause corresponds to the top phrase in the parsed graph of the sentence. A dependent clause is a part of a sentence that depends on, clarifies, or expands, another part of the sentence. A phrase within parentheses is an example of a dependent clause.

For example, a sentence reads, “Revenue information for city of Chicago.” While such a sentence without a verb-phrase is not grammatically correct in English, the sentence is sufficient to operate as the title of a table that includes the revenue information for the city of Chicago.

The illustrative embodiments recognize that some text may separate the title from the corresponding structured data. For example, the above sentence “Revenue information for city of Chicago” may be followed by a parenthetical, “(In Millions of Dollars)” or “revenue numbers are presented in Millions of Dollars.” Such a sentence may include a verb-phrase, may contain other information, such as the parentheses, and be present in an intervening position between the title and the structured data. An embodiment analyzes such intervening information within a search boundary to designate the information as a sub-title associated with the structured data.

A search boundary can be implied or pre-defined. One embodiment finds an implied search boundary. Another embodiment pre-defines a search boundary. An implied search boundary according to one embodiment is reached when the embodiment finds the first text portion that qualifies as a title for the structured data. Such an embodiment is useful when the title is expected to be somewhat removed from structured data with intervening text. An implied search boundary according to another embodiment is the embodiment finds the first text portion that includes a verb-phrase. Such an embodiment is useful when the title is expected to be adjacent to the structured data with no intervening sentences and only dependent clauses.

A pre-defined search boundary according to an embodiment is a predetermined distance from the structured data within which the search for the title is to be conducted. For example, one embodiment may set the distance to one paragraph. As another example, another embodiment may set the distance to three sentences. In yet another embodiment explicit markup, e.g., section boundary markup, may signify text boundary. Furthermore, more than one different criteria may be used in combination to identify a search boundary. These criteria may also utilize fizzy logic, machine learning, artificial intelligence and other techniques. Within the scope of this disclosure, a reference to a search boundary contemplates the implied search boundaries of the various types described herein, and pre-defined boundaries of the various types described herein, modifications conceivable thereto, and combinations thereof.

An embodiment identifies the title and the sub-titles and provides them in association with the contents of the structured data such that a NLP engine or other language processing technology can process them together. For example, one embodiment merges the title and any sub-title information with the contents of the structured data in a modified version of the original document. The embodiment then supplies the modified version of the document as an input to a NLP engine for further processing.

The illustrative embodiments are described with respect to certain documents and certain types of structured data only as examples. Such documents, types of structured data, or their example attributes are not intended to be limiting to the invention.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

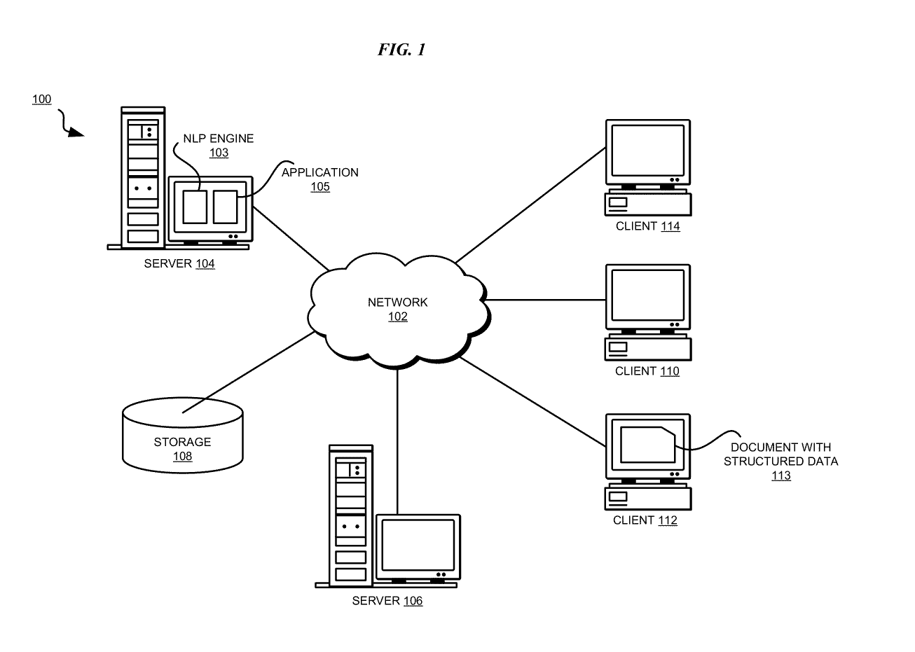

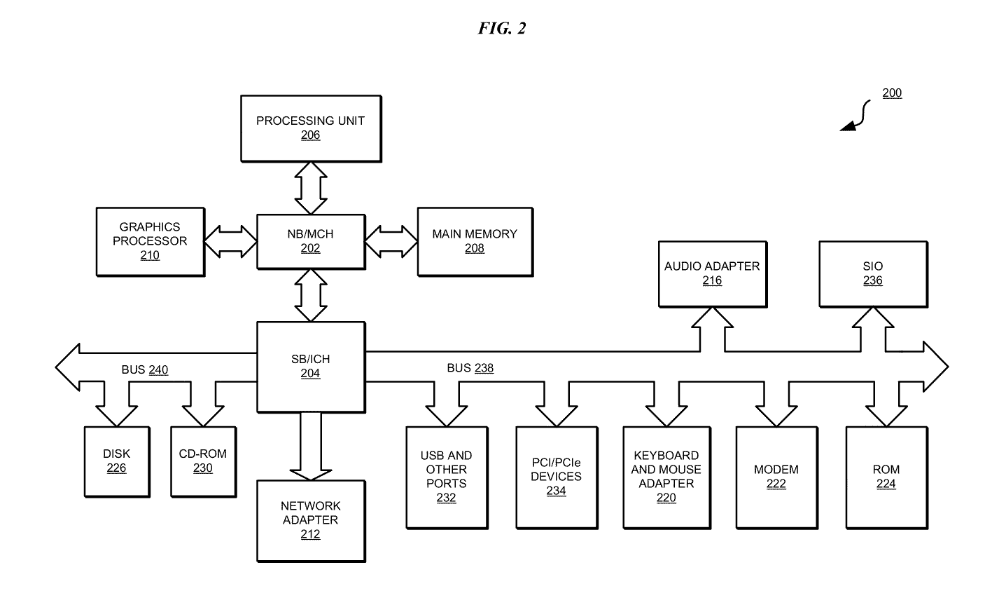

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, Application 105 in server 104 is an implementation of an embodiment described herein. Application 105 operates in conjunction with NLP engine 103. NLP engine 103 may be, for example, an existing application capable of performing natural language processing on documents, and may be modified or configured to operate in conjunction with application 105 to perform an operation according to an embodiment described herein. Client 112 includes document with structured data 113 that is processed according to an embodiment.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 112 in FIG. 1, or another type of device in which computer usable program code or instructions implementing the processes may be located for the illustrative embodiments.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive 226, CD-ROM 230, and other similarly usable devices are some examples of computer usable storage devices including computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on at least one of one or more storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

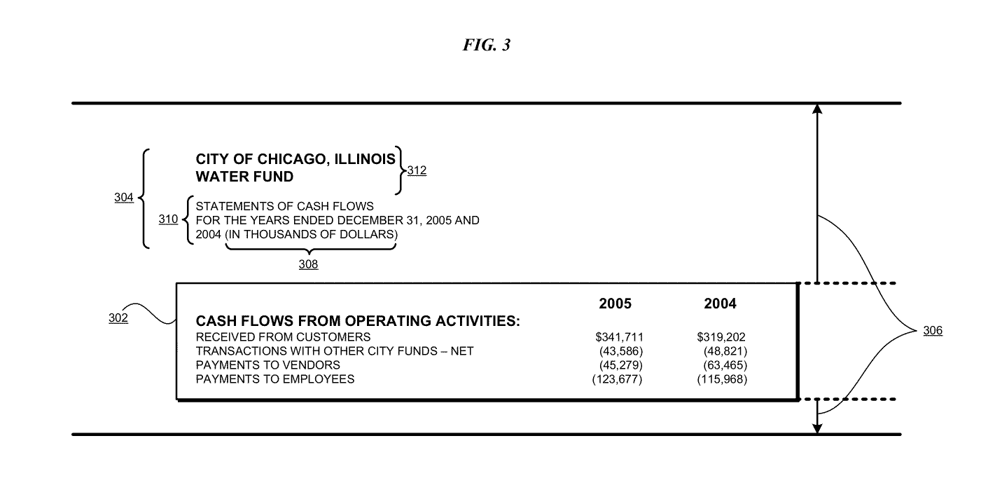

With reference to FIG. 3, this figure depicts an example of structured data whose title and sub-title information can be identified in accordance with an illustrative embodiment. Table 302 is an example of structured data appearing in document 113 in FIG. 1 whose title and sub-title are identified using application 105 in FIG. 1.

Structured data 302 includes data organized according to some structure. In the depicted example, three columns and five rows organize the data in structured data 302. Considering only the data in these three columns and five rows, a user or an application cannot determine a context for this cash flow information.

An embodiment uses search boundary 306 relative to structured data 302. Search boundary 306 can be preset or implied using any of the example methods described in this disclosure. Other comparable methods will be conceivable by those of ordinary skill in the art from this disclosure and the same are contemplated within the scope of the illustrative embodiments.

Search boundary 306 can be above structured data 302, below structured data 302, or both. An embodiment can search for the title and any sub-title in one or both directions. Under certain circumstances, such as in some languages, search boundary 306 can be to the left and right of structured data 302 as well.

For the clarity of the description, assume that an embodiment searches for the title and any sub-titles above structured data 302 up to boundary 306, which may be preset (shown), or implied based on the findings of the search (not shown). In other words, boundary 306 may be realized by the search when a condition of the search is met.

An embodiment searches for sentences that are devoid of verb-phrases. In one embodiment, the search is further modified to not only look for sentences devoid of verb-phrases but to look for sentences that include only noun-phrases. In another embodiment, the search is modified to look for a sentence that is devoid of verb-phrases in the independent clause even if verb-phrases are present in dependent clauses of the sentence. Searching backwards from structured data 302 towards top boundary 306, an embodiment encounters parenthetical text 308. Parenthetical text 308 is a dependent clause of a sentence that includes no verb-phrases. The embodiment continues the search to determine whether more sentences devoid of verb-phrases are present before top boundary 306.

The embodiment determines that all the text in portion 310 qualifies as the title. The search progresses towards top boundary 306 and encounters sentence 312, which also qualifies as a title.

Further search above sentence 312 encounters sentences (not shown) with verb-phrases. Accordingly, the embodiment implies boundary 306 at the beginning of sentence 312 and determines that sentence 312 is where the title of structured data 302 starts.

In one embodiment, sentence 312, portion 310, and sentence 308 are together regarded as the title for structured data 302. In another embodiment, last sentence to qualify as the title, to wit, sentence 312, is designated the title, and intervening sentences between that title and structured data 302, such as portion 310, whether they qualify as a title or not, are designated sub-titles.

In another embodiment, another rule or logic is used to designate some part of portion 310 as title and some other part of portion 310 as sub-title. For example, one example rule for such purpose can be to consider intervening text outside of parentheses as title and within parentheses as sub-title. Accordingly, sentence 308 forms a sub-title for structured data 302, and remainder of portion 310 and sentence 312 together for the title of structured data 302.

Similar logic applies when searching for title and sub-title towards bottom boundary 306. An embodiment can also combine the search results obtained from searching towards more than one search boundary 306 to obtain the tile and/or sub-title for structured data 302.

In some cases, a title may not be found within boundary 306. Such a case may be encountered when boundary 306 is too close to structured data 302. Another reason for failing to find a title can be that the document includes a title that fails to meet a criterion set out by an embodiment for qualifying a sentence as a title.

For example, a sentence that includes a verb-phrase does not meet one criterion—sentence has to be devoid of verb-phrases—to qualify a sentence as a title. As another example, a sentence that includes other phrases, such as adjectives in addition to or instead of noun-phrases, does not meet another criterion—sentence can include only noun-phrases—set out by another embodiment for qualifying a sentence as a title.

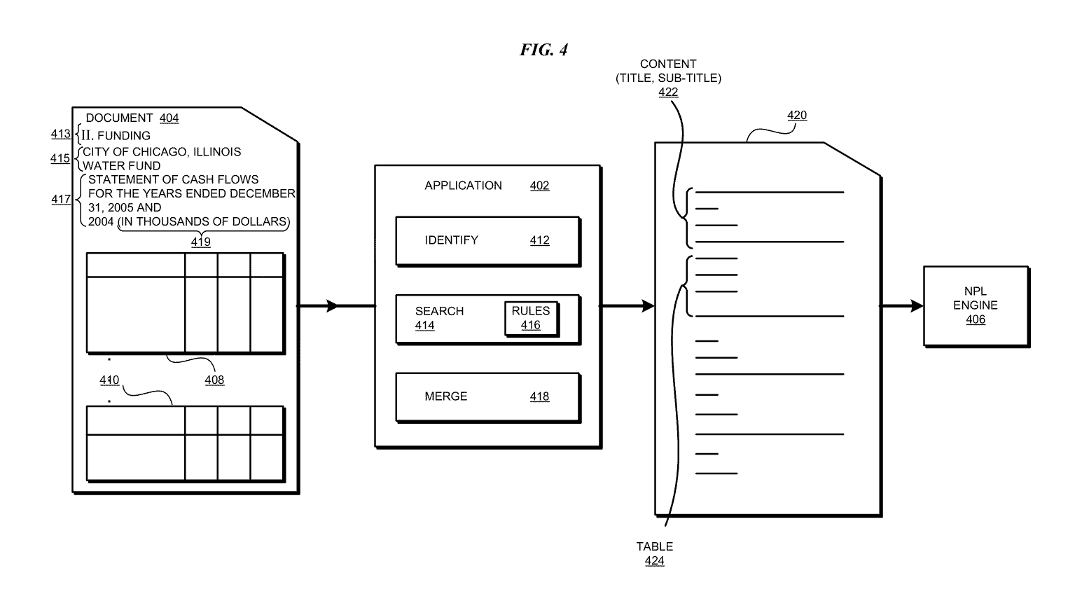

With reference to FIG. 4, this figure depicts a block diagram of an example configuration for discovering title information for structured data in a document in accordance with an illustrative embodiment. Application 402 is an example of application 105 in FIG. 1. Document 404 is an example of document with structured data 113 in FIG. 1. NLP engine 406 is an example of NLP engine 103 in FIG. 1.

Document 404 includes a set of structured data instances, such as tables 408 and 410. Tables 408 and 410 are used as examples of structured data only for the clarity of the description and not for implying any limitation on the types of structured data possible to be included in document 404. Document 404 can include any number of structured data instances without limitation. As an example, and without implying a limitation on the illustrative embodiments, assume that table 408 is similar to table 302 in FIG. 3.

Application 402 includes component 412, which identifies the presence of structured data instances in document 404. For example, in one embodiment, component 412 identifies table 408 by the presence of visual grid markings, indentations, document markup tags such as HTML tags, or a combination thereof. Any suitable way of identifying the presence of structured data can be employed in component 412 without limitation.

Component 412 further identifies a search boundary in document 404. Generally, any boundary condition can be used to define the search boundary for an embodiment. For example, presence of a section header can be used as a boundary condition for defining a search boundary. Accordingly, component 412 identifies sentence 413 as a section header by the presence of section numbering. Component 412 defines sentence 413 as the search boundary. More than one search boundaries in more than one direction relative to structured data 408 can be similarly defined using same or different boundary conditions.

Application 402 includes component 414 for searching for title text and any sub-titles. Component 414 can use a set of rules, such as rule 416 according to which component 414 qualifies a sentence as a title. An example rule in rules 416 can be that the independent clause of the sentence has to be devoid of verb-phrases. Another example rule in rules 416 can be that the independent clause of the sentence has to include only noun-phrases and be devoid of verb-phrases.

Rules 416 are depicted as a part of application 402, as a part of component 414 only as an example. Rules 416 can be located anywhere on a data network and be accessible to application 402 without limitation.

As an example, using sentence 413 as a search boundary in the example manner of operation described with respect to FIG. 3, component 414 identifies sentence 415 as the title for structured data 408. Component 414 identifies text 417, which includes parenthetical text 419 as possible sub-title candidates. In one embodiment, such as according to one example rule in rules 416, component 414 designates sentence 415 as the title of structured data 408 and designates text 417 including text 419 as the sub-title. In another embodiment, such as according to another example rule in rules 416, component 414 designates sentence 419 as the sub-title of structured data 408 and designates remainder of text 417 and text 415 as the title.

The example rules for search and designation are not intended to be limiting on the illustrative embodiments. Many other rules for searching and designating text as title or sub-title will be apparent from this disclosure to those of ordinary skill in the art and the same are contemplated within the scope of the illustrative embodiments.

Optionally, application 402 includes component 418, which merges the identified title and sub-title in a different form into document 420. In one embodiment, as shown, document 420 includes content 422, which corresponds to title and/or sub-title data from document 404, and table 424, which, for example, corresponds to table 408 of document 404. Document 420 then serves as an input for further processing, such as an input to NLP engine 406. An embodiment can also output document 420 for other purposes such as, for example, audio conversion for the blind.

In another embodiment, component 418 does not merge content 422 in to document 420, but provides content 422 via another document or input to NLP engine 406. For example, in such an embodiment, component 418 stores content 422 in storage 108 in FIG. 1, and NLP engine 406 extract the stored titles and sub-titles from storage 108 in FIG. 1 as an input for processing document 404.

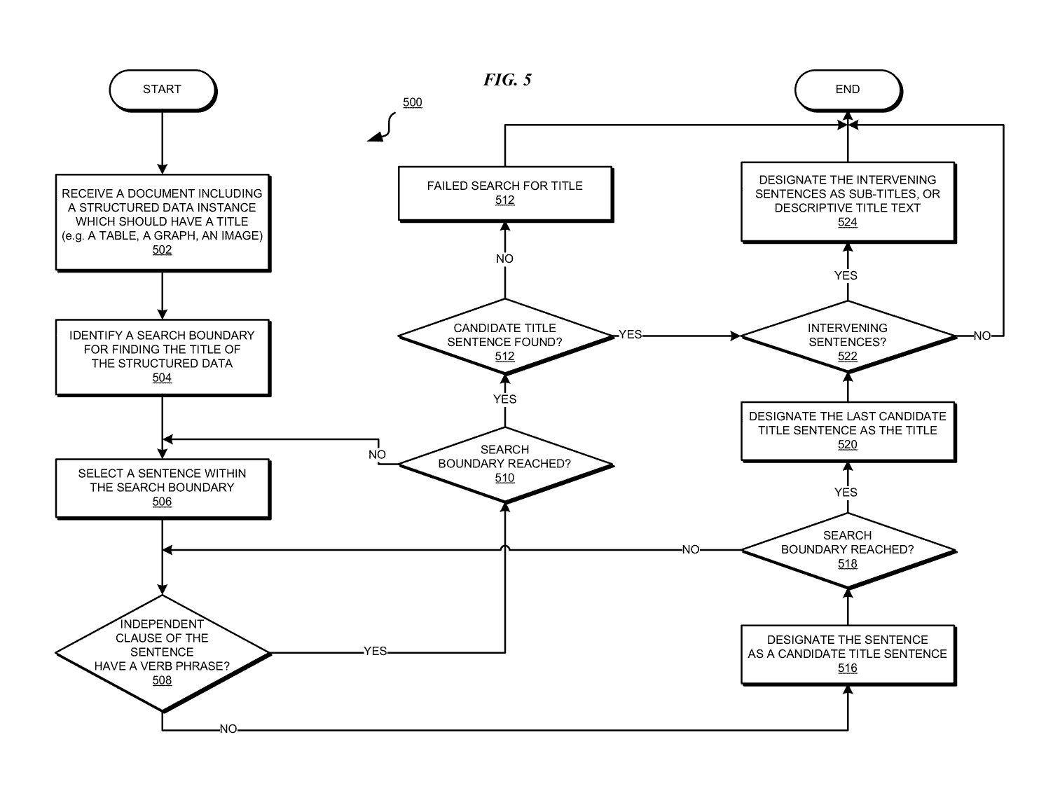

With reference to FIG. 5, this figure depicts a flowchart of an example process for discovering title information for structured data in a document in accordance with an illustrative embodiment. Process 500 can be implemented in application 402 in FIG. 4.

Process 500 begins by receiving a document that includes a structured data instance that should have a title (step 502). A set of one or more structured data instances may exist in the document. Process 500 identifies a search boundary of finding the title of the structured data (step 504).

Process 500 selects a sentence within the search boundary (step 506). Process 500 determines whether the selected sentence is a verb-phrase (step 508). If the selected sentence is a verb-phrase (“Yes” path of step 508), process 500 determines whether the search boundary has been reached (step 510). If the search boundary is not reached (“No” path of step 510), process 500 returns to step 506 and selects another sentence closer towards the search boundary.

If the search boundary is reached (“Yes” path of step 510), process 500 determines whether any candidate title sentences were found (step 512). If no candidate title sentences were found (“No” path of step 512), process 500 declares a failure in searching for the title (step 514). Process 500 ends thereafter. If a candidate title sentence was found (“Yes” path of step 512), process 500 proceeds to step 522. In one embodiment, instead of ending, after step 514, process 500 may optionally employ (not shown) a presently used less accurate method for identifying the title. In another embodiment, instead of ending, after step 514, process 500 may optionally allow (not shown) a user to specify the title.

Returning to step 508, if process 500 determines that the independent clause of the selected sentence is devoid of verb-phrases (“No” path of step 508), process 500 designates the sentence as a candidate title sentence (step 516). Process 500 determines whether the search boundary has been reached (step 518). If the search boundary is not reached (“No” path of step 518), process 500 returns to step 506 for find more candidate title sentences.

If the search boundary is reached (“Yes” path of step 518), process 500 designates the last candidate title sentence closest to the search boundary as the title of the structured data (step 520). Process 500 determines whether there are intervening sentences between the title sentence and the structured data (step 522). If intervening sentences are present (“Yes” path of step 522), process 500 designates the intervening sentences as sub-titles (step 524). Process 500 ends thereafter. If intervening sentences are not present (“No” path of step 522), process 500 ends thereafter.

Optionally, after process 500 ends with sentences designated as titles or sub-titles, process 500 can (not shown) store the titles and/or sub-titles in a modified version of the document received in step 502, or in a repository. Other ways of communicating the titles and sub-titles to a next step in document processing are also contemplated within the scope of the illustrative embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for discovering title information for structured data in a document. An embodiment recognizes the title text associated with a structured data instance in a document. An embodiment also recognizes any sub-titles or descriptive texts associated with the title or the structured data. The embodiment provides the title and any sub-titles to the next stage in document processing, such as NLP.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for discovering title information in a document, the method comprising:
identifying an instance of structured data in a document;
identifying a search direction relative to a location of the instance, wherein a title describing the instance is located in a document portion in the search direction from the instance;
selecting a sentence in the document portion;
determining whether the selected sentence qualifies as a title by determining whether an independent clause in the selected sentence includes a verb-phrase; and
designating, responsive to the selected sentence qualifying as the title, the selected sentence as a candidate title for the instance.

2. The method of claim 1, further comprising:
reaching a second sentence farther from the sentence in the search direction;
determining whether the second sentence includes a verb-phrase in an independent clause of the second sentence;
concluding that, responsive to the second sentence including the verb-phrase in the independent clause of the second sentence, the selected sentence is the candidate title and setting the sentence as the search boundary; and
designating the selected sentence as the title for the instance.

3. The method of claim 2, further comprising:
designating the second sentence as a second candidate title for the instance responsive to the second sentence not including the verb-phrase in the independent clause of the second sentence; and
selecting a third sentence farther away from the second sentence in the document portion;
determining whether the third sentence also qualifies as the title; and
setting the second sentence as the search boundary responsive to the third sentence not qualifying as the title.

4. The method of claim 2, further comprising:
providing the title for document processing, wherein the providing comprises storing information describing the title in a modified version of the document.

5. The method of claim 1, further comprising:
determining whether a text portion intervenes between the candidate title and the instance in the document portion;
designating, responsive to the text portion intervening between the candidate title and the instance, the text portion as a sub-title for the instance.

6. The method of claim 5, wherein the text portion includes a second sentence that also qualifies as a second title.

7. The method of claim 1, further comprising:
determining whether the independent clause of the selected sentence includes only noun-phrases, wherein the designating is responsive to the independent clause of the selected sentence including only noun-phrases.

8. The method of claim 1, further comprising:
identifying a second document portion, wherein the document portion and the second document portion are in different directions relative to the location of the instance, and wherein the title is expected to be located in the document portion and the second document portion.

9. The method of claim 1, wherein the instance organizes content in a data structure.

10. The method of claim 1, wherein the data structure is a table.

11. The method of claim 1, further comprising:
receiving the document for natural language processing; and
providing information about the title to a natural language processing engine.

12. A computer usable program product comprising a computer usable storage device including computer usable code for discovering title information in a document, the computer usable code comprising:
computer usable code for identifying an instance of structured data in a document;
computer usable code for identifying a search direction relative to a location of the instance, wherein a title describing the instance is located in a document portion in the search direction from the instance;
computer usable code for selecting a sentence in the document portion;
computer usable code for determining whether the selected sentence qualifies as a title by determining whether an independent clause in the selected sentence includes a verb-phrase; and
computer usable code for designating, responsive to the selected sentence qualifying as the title, the selected sentence as a candidate title for the instance.

13. The computer usable program product of claim 12, further comprising:
computer usable code for reaching a second sentence farther from the sentence in the search direction;
computer usable code for determining whether the second sentence includes a verb-phrase in an independent clause of the second sentence;
computer usable code for concluding that, responsive to the second sentence including the verb-phrase in the independent clause of the second sentence, the selected sentence is the candidate title and setting the sentence as the search boundary; and
computer usable code for designating the selected sentence as the title for the instance.

14. The computer usable program product of claim 13, further comprising:
computer usable code for designating the second sentence as a second candidate title for the instance responsive to the second sentence not including the verb-phrase in the independent clause of the second sentence; and
computer usable code for selecting a third sentence farther away from the second sentence in the document portion;
computer usable code for determining whether the third sentence also qualifies as the title; and
computer usable code for setting the second sentence as the search boundary responsive to the third sentence not qualifying as the title.

15. The computer usable program product of claim 13, further comprising:
computer usable code for providing the title for document processing, wherein the providing comprises storing information describing the title in a modified version of the document.

16. The computer usable program product of claim 12, further comprising:
computer usable code for determining whether a text portion intervenes between the candidate title and the instance in the document portion;
computer usable code for designating, responsive to the text portion intervening between the candidate title and the instance, the text portion as a sub-title for the instance.

17. The computer usable program product of claim 16, wherein the text portion includes a second sentence that also qualifies as a second title.

18. The computer usable program product of claim 12, wherein the computer usable code is stored in a computer readable storage medium in a data processing system, and wherein the computer usable code is transferred over a network from a remote data processing system.

19. The computer usable program product of claim 12, wherein the computer usable code is stored in a computer readable storage medium in a server data processing system, and wherein the computer usable code is downloaded over a network to a remote data processing system for use in a computer readable storage medium associated with the remote data processing system.

20. A data processing system for discovering title information in a document, the data processing system comprising:
a storage device including a storage medium, wherein the storage device stores computer usable program code; and
a processor, wherein the processor executes the computer usable program code, and wherein the computer usable program code comprises:
computer usable code for identifying an instance of structured data in a document;
computer usable code for identifying a search direction relative to a location of the instance, wherein a title describing the instance is located in a document portion in the search direction from the instance;
computer usable code for selecting a sentence in the document portion;
computer usable code for determining whether the selected sentence qualifies as a title by determining whether an independent clause in the selected sentence includes a verb-phrase; and
computer usable code for designating, responsive to the selected sentence qualifying as the title, the selected sentence as a candidate title for the instance.
